(19) United States
(12) Patent Application Publication
(10) Pub. No.: US 2004/0072581 A1
(43) Pub. Date: Apr. 15, 2004

(54) Electronic apparatus that performs wireless communication and wireless communication control method for use in the electronic apparatus

(75) Inventors: Takeshi Tajima, Minato-ku (JP); Mitsunobu Aoyama, Fukaya-shi (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/671,965

(22) Filed: Sep. 26, 2003

(30) Foreign Application Priority Data
Oct. 15, 2002 (JP) 2002-300912

(51) Int. Cl. H04Q 7/20

(52) U.S. Cl. 455/456.1; 455/427

(57) ABSTRACT

An electronic apparatus performs wireless communication selectively using one of a first wireless communication device for performing wireless communication by a first wireless communication system and second wireless communication device for performing wireless communication by a second wireless communication system. The electronic apparatus includes a unit for storing base station information relating to a position of a base station corresponding to a first wireless communication system and a position of a base station corresponding to a second wireless communication system, a unit for detecting a current position of the electronic apparatus, and a unit for switching between the first wireless communication device and the second wireless communication device based on the detected current position of the electronic apparatus and the base station information.

### CROSS-REFERENCE TO RELATED APPLICATIONS

This application is based upon and claims the benefit of priority from the prior Japanese Patent Application No. 2002-300912, filed Oct. 15, 2002, the entire contents of which are incorporated herein by reference.

### BACKGROUND OF THE INVENTION

1. Field of the Invention

The present invention relates to an electronic apparatus used as a mobile station such as a mobile information terminal and in-car electronic equipment and a wireless communication control method for use in the electronic apparatus.

2. Description of the Related Art

A car navigation system has been knows as typical on-vehicle electronic device that is installed in a car.

The car navigation system retrieves a map from a map database and displays it on the screen, with a car position indicator, to provide road information and guide the car to a destination. The position of the car is detected by a position detecting system such as a GPS (global positioning system).

Recently, a car navigation system having a function of displaying a variety of supplementary information items that are stored in the map database as well as information items of road information and route guidance has been developed.

Jpn. Pat. Appln. KOKAI Publication No. 2002-221430 (pages 7 and 8) discloses a car navigation system that is capable of displaying supplementary information. In this system, information of facilities such as restaurants and gas stations is previously stored in a map database and facilities in the vicinity of a car are retrieved therefrom when the need arises.

In a method using supplementary information that is previously stored in a map database, however, it is actually difficult to present a user in real time with up to date details of service which are currently provided in facilities such as restaurants and gas stations since these services may have changed since the map database was produced.

It is therefore desirable to achieve a method of acquiring necessary information from outside, that is apart from the fixed map database, through the Internet or the like in real time. To do so, it is necessary to use a high-speed wireless communication system such as, for example, a wireless LAN that conforms to the IEEE 802.11 standard.

However, there are a few places where base stations (or access points) corresponding to a wireless LAN are provided at present. Moreover, the radius of a communication area that is covered by one base station corresponding to the wireless LAN is about 200 m, which is much less than that of a communication area that is covered by a base station corresponding to a commonly-used mobile telephone system.

Consequently, the wireless LAN can be used only in a specific area, and a wireless communication with the outside cannot be performed when the car is located in a area other than the specific area.

### BRIEF SUMMARY OF THE INVENTION

An object of the present invention is to provide an electronic apparatus and a wireless communication control method capable of carrying out communication with the outside irrespective of the position of a car.

In accordance with the teachings of the invention, an electronic apparatus performs wireless communication by selectively using one of a first wireless communication device for performing wireless communication by a first wireless communication system and a second wireless communication device for performing wireless communication by a second wireless communication system. The electronic apparatus has a device for storing base station information relating to a position of a base station corresponding to the first wireless communication system and a position of a base station corresponding to the second wireless communication system. The apparatus further has a position detector for detecting a current position of the electronic apparatus; and a switching device for switching between the first wireless communication device and the second wireless communication device based on the current position of the electronic apparatus detected by the position detector and the base station information.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of in-car electronic equipment according to an embodiment of the present invention;

FIG. 2 is a chart showing an example of a relationship between a moving route of the in-car electronic equipment according to the embodiment and a communication area of each of first to third wireless communication systems;

FIG. 3 is a diagram describing how communication devices are selected when the in-car electronic equipment according to the embodiment moves along the moving route shown in FIG. 2;

FIG. 4 is a chart showing a base station information database used in the in-car electronic equipment according to the embodiment;

FIG. 5 is a flowchart describing a first example of a communication device selecting process that is performed by the in-car electronic equipment according to the embodiment;

FIG. 6 is a flowchart describing a second example of the communication device selecting process that is performed by the in-car electronic equipment according to the embodiment;

FIG. 7 is a flowchart describing a process for selecting a communication device to be used by the in-car electronic equipment according to the embodiment in accordance with the moving speed of the in-car electronic equipment; and

FIG. 8 is a flowchart describing a high-speed prediction roaming process that is performed by the in-car electronic equipment according to the embodiment.

### DETAILED DESCRIPTION OF THE INVENTION

An embodiment of the present invention will now be described with reference to the accompanying drawings.

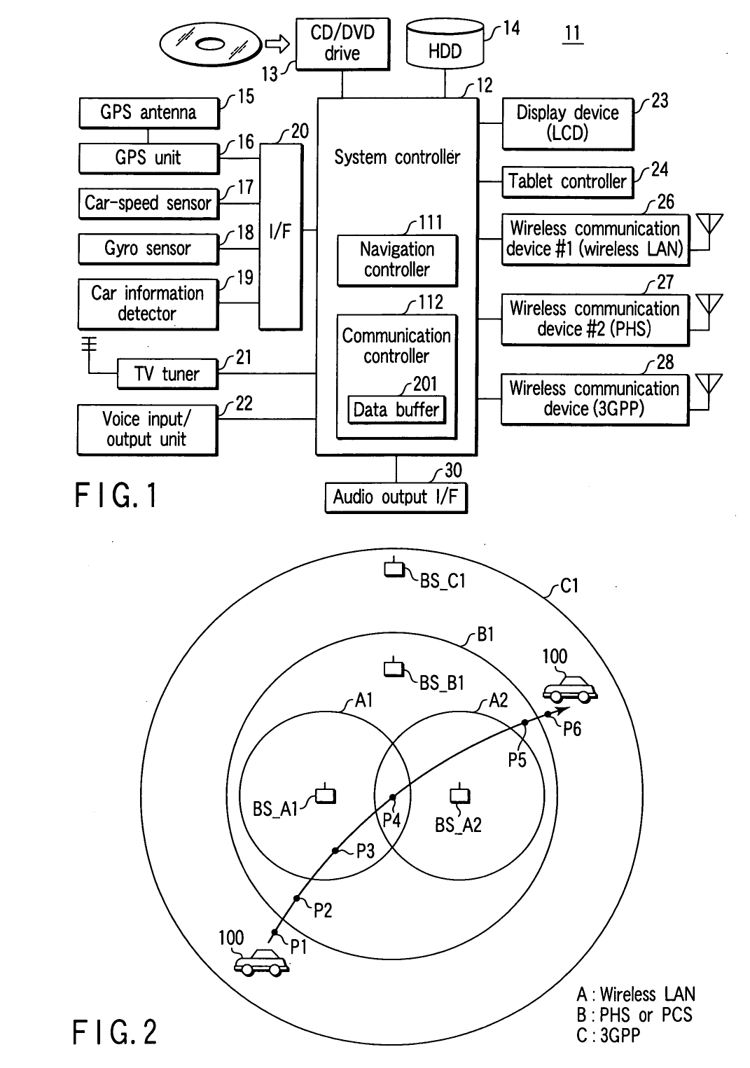

FIG. 1 shows a configuration of in-car electronic equipment 11 according to an embodiment of the present invention. The equipment 11, an on-vehicle electronic apparatus is installed in a car. The equipment 11 includes a system controller 12, a CD/DVD drive 13 and a storage device 14, as shown in FIG. 1.

The system controller 12 is a processor that performs various information processes for controlling an operation of the in-car electronic equipment 11. The system controller 12 includes a navigation controller 111 to perform a car navigation function and a communication controller 112 to perform a wireless communication function. The communication controller 112 serves as a gateway for connecting the in-car electronic equipment 11 to an external IP (Internet Protocol) network such as the Internet. All the communication with the Internet is controlled by the communication controller 112.

The car navigation function of the navigation is controller 111 is a function of displaying a map of the periphery of a car on the screen to provide road information and guide the car to a destination.

The wireless communication function of the communication controller 112 is a function of communicating with the outside via the Internet or the like. For example, it is used to receive service information about respective facilities in the vicinity of the car or in the vicinity of the destination of the car from the Internet or the like. The service information is electronic information indicating the contents of service provided by the facilities such as restaurants, gas stations, convenience stores, movie theaters, museums, service areas and amusement parks.

In order to carry out wireless communication with the outside, the in-car electronic equipment 11 includes first to third wireless communication devices 26 to 28. These wireless communication devices 26 to 28 are so configured that they can perform their wireless communications by different wireless communication systems. In the wireless communication with the outside, the first to third wireless communication devices 26 to 28 are selectively used.

The first wireless communication device 26 carries out wireless communication by a wireless communication system (first wireless communication system) corresponding to the wireless LAN that conforms to, for example, the IEEE 802.11 standard.

The communication speed of the first wireless communication device 26 is, for example, 54 Mbps. The device 26 performs wireless communication with base stations (or so-called access points) corresponding to the wireless LAN. The communication area (zone or cell) of each base station has a radius of about 100 m to 200 m from the position of the base station.

The second and third wireless communication devices 27 and 28 carry out their wireless communications by wireless communication systems corresponding to different mobile telephone systems.

The present embodiment is directed to the following cases. The second wireless communication device 27 is adapted to a wireless communication system (second wireless communication system) such as a PHS (personal handy phone system) and a PCS (personal communication system). The third wireless communication device 28 is adapted to a wireless communication system (third wireless communication system) such as a 3GPP (3rd generation partnership project), which is the standard of the third generation wideband mobile telephone system.

The second wireless communication device 27 carries out wireless communication with the base stations corresponding to the second wireless communication system. The communication speed of the device 27 is about 32 kbps to 128 kbps. The communication area (zone or cell) of each base station has a radius of about 500 m from the position of the base station.

The third wireless communication device 28 performs wireless communication with base stations corresponding to the third wireless communication system. The communication speed of the device 28 is about 384 kbps. The communication area (zone or cell) of each base station has a radius of about several kilometers to more than ten kilometers from the position of the base station.

The first to third wireless communication systems vary in wireless communication availability or size coverage area and/or transmission strength or field intensity of a carrier wave (i.e., environment) according to the current position of a car in which the in-car electronic equipment 11 is installed. For example, it may be that all of the first to third wireless communication systems can be used in a first vehicle position, whereas only the third wireless communication system may be used in a second vehicle position.

The communication controller 112 has a communication device selecting function of automatically selecting a wireless communication device to be used for communicating with the outside from among the first to third wireless communication devices 26 to 28 in accordance with the wireless communication environment of each of the first to third wireless communication systems in the current position of a car. This function makes it possible to automatically select a wireless communication device that is the most suitable for the current position of the car. Since the controller 112 operates automatically, the user need not take into consideration the type of communication device used for communication with the outside.

When the car is located in a position capable of using at least two of the first to third wireless communication systems, a wireless communication device having the highest priority is selected from the usable wireless communication devices based on the predetermined priority.

The priority is predetermined in terms of communication speed, communicationcost, and the like. Hereinafter, assume that the first wireless communication device 26 has the highest priority, the second wireless communication device 27 has the second highest priority, and the third wireless communication device 28 has the lowest priority.

The communication controller 112 also has a data buffer 201 for temporarily holding data, which is to be transmitted to and received from the outside, in order to seamlessly select a communication device during communication with the outside. In the selection of a communication device during the communication with the outside, a physical connection between a wireless communication device currently used for communication with the outside and a communication partner (e.g., a server on the Internet) is temporarily released; however, immediately after that, a newly selected wireless communication device is connected again to the partner. Though the download of contents data from the server on the Internet is interrupted, it can be continued by the newly selected wireless communication device. It is thus possible to select a communication device without making a user aware of even a temporary disconnection from the server.

The CD/DVD drive 13 is used to read a map database out of a storage media such as a CD and a DVD inserted therein. The map database is a database that stores map information including maps and positional information of various facilities. The map database also includes a base station information database used for the communication device selecting function described above.

The base station information database is a database which stores base station information relating to the positions of three different base stations corresponding to the first to third wireless communication systems. The communication controller 112 determines the wireless communication environment of each of the first to third wireless communication systems in the current position of a car on the basis of the position of the car and the base station information database in order to automatically select a wireless communication device that is the most suitable for communication with the outside.

The storage device 14 is made up of, for example, a hard disk drive (HDD) that is capable of storing various items of contents data. The storage device 14 is also capable of storing the map database in advance. In this case, the system controller 12 can read necessary map information out of the storage device 14 without using the CD/DVD drive 13. In one embodiment of the invention, data for the map database is downloaded from the server on the Internet by wireless communication. In such a case, map information, base station information, supplemental service information etc. can be updated.

The in-car electronic equipment 11 further includes a GPS unit 16, a car-speed sensor 17, a gyro sensor 18 and a car information detector 19, which are connected to the system controller 12 via an interface unit 20.

The GPS unit 16 is a position detecting device for detecting the current position of a car. The GPS unit 16 receives radio waves from a plurality of satellites through a GPS antenna 15 and measures the location (latitude and longitude) of the car.

The car-speed sensor 17 and gyro sensor 18 are sensors for sensing the driving speed and driving direction of the car. The car information detector 19 detects various items of car information such as a condition that the car gear is in reverse, a handbrake is set and the like.

The in-car electronic equipment 11 further includes a TV tuner 21, a voice input/output unit 22, a display device 23, a tablet controller 24 and an audio output interface 30.

The TV tuner 21 is a device that receives various broadcast signals of satellite broadcasting, ground-based broadcasting and the like and selects a station. The voice input/output unit 22 is used to fulfill a voice control function for controlling an operation of the in-car electronic equipment 11 in response to the input voice of a user and performs a voice prompt regarding the guidance of a route.

The display device 23 is an in-car monitor (e.g., an LCD monitor) for presenting various information items to a user. The display device 23 is used to display map information for car navigation, contents data received by the wireless communication devices 26 to 28, TV programs received by the TV tuner 21, and the like.

The tablet controller 24 is an input device for instructing the system controller 12 to perform various operations in accordance with a user's operation. The tablet controller 24 may, for example, take the form of a transparent coordinate detecting device placed on the display screen of the display device 23. Thus, the display screen of the display device 23 serves as a touch screen. A user can touch the buttons displayed on the touch screen to provide instructions for performing the operations. The audio output interface unit 30 is a device for connecting the in-car electronic equipment 11 to in-car audio equipment.

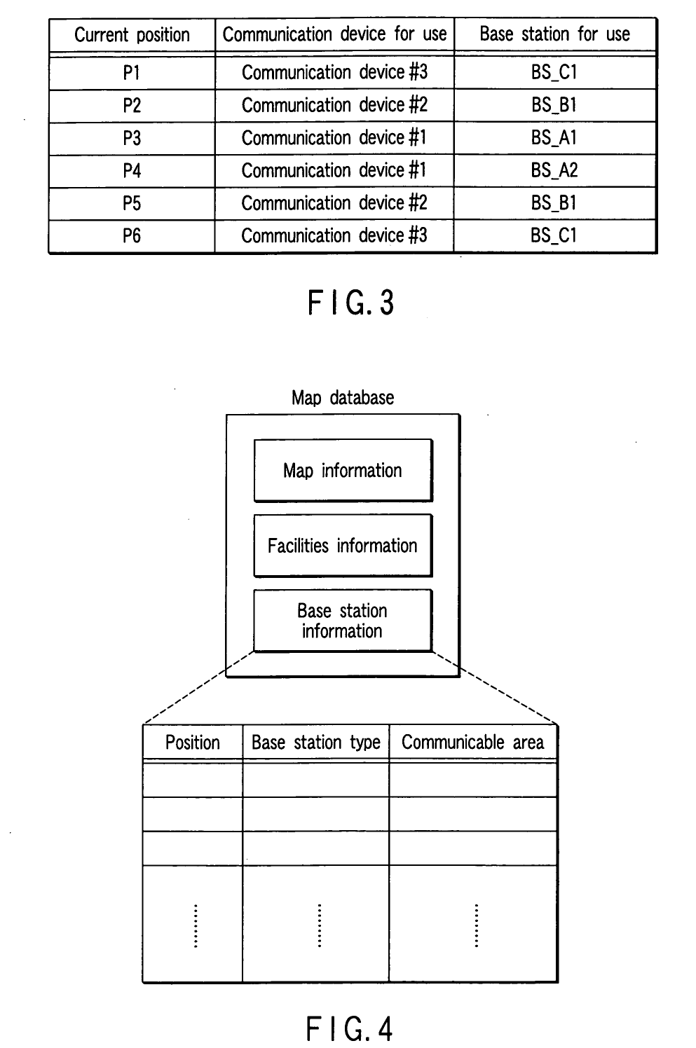

The communication device selecting function of the communication controller 112 will now be described with reference to FIGS. 2 and 3.

FIG. 2 shows an example of the locations of communication areas (zones or cells) of the first to third wireless communication systems in a certain region.

As described above, the communication area for one base station in the first wireless communication system (wireless LAN) is the smallest, that in the third wireless communication system (3GPP) is the largest, and that in the second wireless communication system (PHS or PCS) is intermediate between them.

Assume that two communication areas Al and A2 corresponding to the first wireless communication system (wireless LAN) are included in a communication area B1 corresponding to the second wireless communication system (PHS or PCS), and the communication area B1 is included in one communication area C1 corresponding to the third wireless communication system (3GPP) as shown in FIG. 2.

The communication area A1 is covered by a base station BS-A1 corresponding to the first wireless communication system (wireless LAN). The communication area A2 is covered by a base station BS-A2 also corresponding to the first wireless communication system (wireless LAN).

The communication area B1 is covered with a base station BS-B1 corresponding to the second wireless communication system (PHS or PCS). The communication area C1 is covered with a base station BS-C1 corresponding to the third wireless communication system (3GPP).

Assume that a car 100 in which the in-car electronic equipment 11 is installed moves from point P1 to point P6 in the route indicated by the arrow in FIG. 2. In this case, the wireless communication environment of each of the first to third wireless communication systems in the current position of the car 100 varies with the movement of the car 100. The communication controller 112 determines the wireless communication environment of each of the first to third wireless communication systems corresponding to the current position of the car 100 and dynamically selects a wireless communication device to be used for wireless communication as shown in FIG. 3.

More specifically, when the current position of the car 100 is located in point P1, it is only the third wireless communication system that is available; therefore, the communication controller 112 selects the third wireless communication device (#3) 28. In point P1, the third wireless communication device (#3) 28 performs wireless communication with the base station BS-C1 corresponding to the third wireless communication system (3GPP).

When the current position of the car 100 is located in point P2, it is the second and third wireless communication systems that are available. Since the second wireless communication system has higher priority than the third wireless communication system, the communication controller 112 selects the second wireless communication device (#2) 27 corresponding to the second wireless communication system. In point P2, the second wireless communication device (#2) 27 performs wireless communication with the base station BS-B1 corresponding to the second wireless communication system (PHS or PCS).

When the current position of the car 100 is located in point P3 or P4, all of the first to third wireless communication systems that are available. Since the first wireless communication system has the highest priority, the communication controller 112 selects the first wireless communication device (#1) 26 corresponding to the first wireless communication system. In point P3, the first wireless communication device (#1) 26 performs wireless communication with the base station BS-A1 corresponding to the first wireless communication system (wireless LAN). In point P4, the first wireless communication device (#1) 26 performs wireless communication with the base station BS-A2 corresponding to the first wireless communication system (wireless LAN).

When the current position of the car 100 is located in point P5, it is the second and third wireless communication systems that are available. Since the second wireless communication system has higher priority than the third wireless communication system, the communication controller 112 selects the second wireless communication device (#2) 27 corresponding to the second wireless communication system. In point P5, the second wireless communication device (#2) 27 performs wireless communication with the base station BS-B1 corresponding to the second wireless communication system (PHS or PCS).

When the current position of the car 100 is located in point P6, it is only the third wireless communication system that is available; therefore, the communication controller 112 selects the third wireless communication device (#3) 28 corresponding to the third wireless communication system. In point P6, the third wireless communication device (#3) 28 performs wireless communication with the base station BS-C1 corresponding to the third wireless communication system (3GPP).

FIG. 4 shows an example of a map database.

The map database includes a map information database storing a map of each region and its corresponding positional information, a facilities information data base storing information of each facility and its corresponding positional information, and a base station information database storing each base station and its corresponding positional information.

The base station information database is a database indicating the position of each of base stations corresponding to each of the first to third wireless communication systems. For example, as shown in FIG. 4, the base station information database indicates the position (latitude and longitude) of each base station, the type (a base station ID, a wireless communication system corresponding to the base station) of the base station, and a communicable area (e.g., the radius of a zone). The base station ID is information for identifying a base station and indicates, for example, an address of the base station.

The communication controller 112 retrieves a base station having a communication area that covers the current position of a car from the base station information database and determines an available wireless communication device in the current position in accordance with the wireless communication system corresponding to the retrieved base station. If two or more wireless communication systems are available, a wireless communication device to be used for wireless communication is determined in accordance with the priority described above.

An example of the communication device selecting process that is performed by the communication controller 112 will now be described with reference to the flowchart shown in FIG. 5.

In order to detect a wireless communication system having a wireless communication environment that covers the current position of a car detected by the GPS unit 16 as a communication area, the communication controller 112 first retrieves base stations that have a communication area that covers the current position of the car from the base station information database on the basis of the current position of the car and the position information of the base stations as determined form the data base information (step S101). In this step S101, all of base stations having a communication area that covers the current position of the car and the wireless communication systems of the base stations are detected.

When a plurality of base stations corresponding to different wireless communication systems are retrieved, the communication controller 112 selects a base station to be used for wireless communication in accordance with the priority of each of the wireless communication systems (step S102).

Then, the communication controller 112 selects a wireless communication device to be used for wireless communication from the first to third wireless communication devices 26 to 28 in accordance with a wireless communication system corresponding to the selected base station (step S103). The communication controller 112 switches a wireless communication device to be used for wireless communication from a wireless communication device that was previously selected (and may be currently used) to the wireless communication device selected in step S103 (step S104).

The communication controller 112 performs communication with the outside using the wireless communication device selected in step S103 (step S105). In this case, the wireless communication device selected in step S103 establishes a wireless connection with the base station selected in step S102 and performs communication with a server on the Internet and the like through the base station.

As described above, a wireless communication device to be used for communication with the outside is automatically switched in accordance with..the movement of a car. It is thus possible to carry out communication with the outside using a wireless communication device that is the most suitable for the current position of the car. In other words, it is possible to carry out communication with the outside from everywhere irrespective of the position to which the car 100 moves. A user need not be aware of the type of a communication device to be used for communication with the outside.

During the movement of the car 100, the optimum base station and wireless communication system to be used are determined in consideration of the moving direction of the car as well as the current position of the car. The moving direction of the car is sensed by the gyro sensor 18.

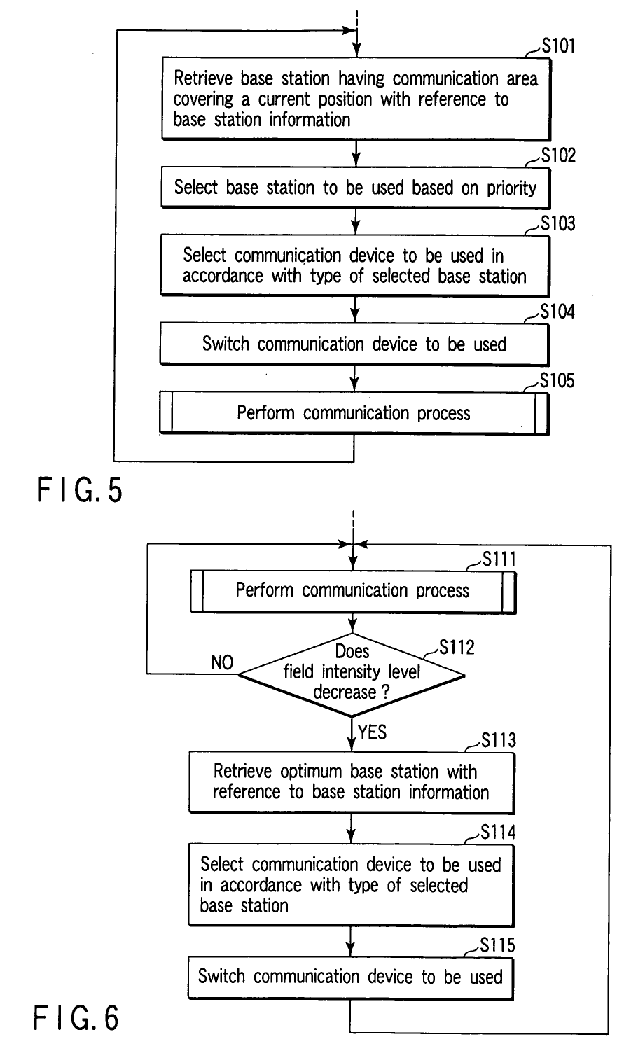

An example of a communication device selecting process that is performed when the communication environment of a wireless communication system currently used for communication with the outside deteriorates will now be described with reference to the flowchart shown in FIG. 6.

Now assume that the first wireless communication device 26 is used to perform communication with the outside (step S111). The communication controller 112 monitors a field intensity level of a carrier signal that is sent to the first wireless communication device 26 from.a base station corresponding to the first wireless communication system (step S112). If the field intensity level decreases to a value that is not higher than a predetermined one (YES in step S112), the communication controller 112 determines that the communication environment of the first wireless communication system corresponding to the first wireless communication device 26 starts to deteriorate and performs the following communication device selecting process.

The communication controller 112 retrieves from the base station information database a base station that is the most suitable for communication with a car (step S113). Of course, in this selection process, the current base station is ignored or given a lowest priority since it was already determined that the transmission strength from this base station was unacceptably low. In step S113, by considering the current position of the car detected by the GPS unit 16 and the moving direction thereof sensed by the gyro sensor 18, a base station in which a good communication environment can be expected is retrieved from those covering the current position of the car as a communication area. If a plurality of base stations (corresponding to the second and third communication systems) having different wireless communication systems, in which a good communication environment can be expected, are retrieved, a base station (corresponding to the second communication system) to be used for wireless communication is selected by the above-described priority.

Then, the communication controller 112 selects a wireless communication device that corresponds to a wireless communication system of the selected base station, e.g., a wireless communication device 27, and switches the first wireless communication device 26 to the selected wireless communication device 27 (steps S114 and S115). In step S115, the wireless communication device 27 establishes a wireless connection with the base station selected in step S113 and is connected to a server on the Internet via the base station. This server is the same as one with which the first wireless communication device 26 communicates in step S111.

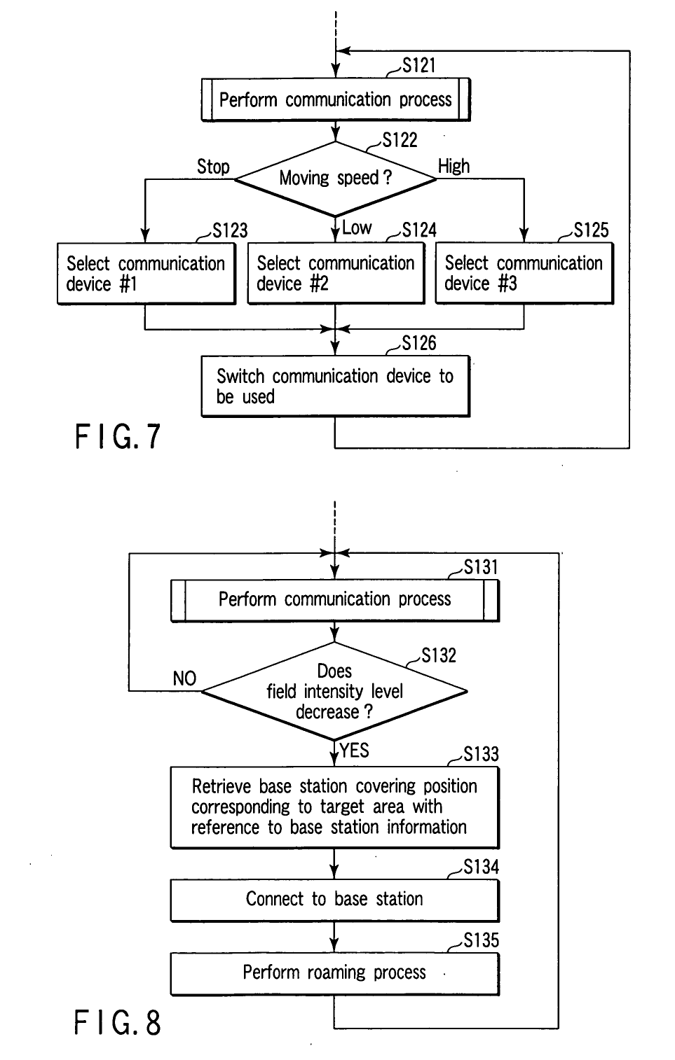

Another example of the communication device selecting process that is performed by the communication controller 112 will now be described with reference to the flowchart shown in FIG. 7.

In this example, when a car is located in a position where at least two of the first to third wireless communication systems are available, a wireless communication device to be used for wireless communication is selected in accordance with not the above-described priority but the current moving speed of the in-car electronic equipment 11 or the current driving speed of the car 100.

The process of selecting a wireless communication device in accordance with the driving speed of a car is performed based on the following policy. The first wireless communication device 26 is selected by priority when the vehicle is stopped, the second wireless communication device 27 is selected by priority during low-speed driving, and the third wireless communication device 28 is selected by priority during the high-speed driving.

Generally, the narrower the communication area which is covered by one base station in a wireless communication system, the larger the number of times roaming must be encountered due to movement of the vehicle. Roaming is a process of selecting a base station to be used for communication with a mobile station from among those of the same wireless communication system (the process is also called a handover).

The communication area that is covered by each base station corresponding to the first wireless communication system (wireless LAN) is narrow. If, therefore, the first wireless communication system is used during high-speed driving, the process of roaming occurs frequently and a connection may be lost. Consequently, a logical communication channel between the equipment 11 and the server is likely to be cut off. From this point of view, in a system selectively using a plurality of wireless communication systems having different communication areas for one base station, a mechanism for selecting a wireless communication system to be used in accordance with the moving speed of the in-car electronic equipment 11 is effective in performing a stable wireless communication.

Now assume that a car is located in an area where only the third wireless communication system is available and the third wireless communication device 28 is selected. The communication with the outside is carried out using the third wireless communication device 28 (step S121).

Assume that the car moves to an area where all of the first to third wireless communication systems are available. In this case, a base station corresponding to each of the first to third wireless communication systems is retrieved from the base station information database as one that is available for wireless communication.

The communication controller 112 detects the moving speed of the in-car electronic equipment 11 or the driving speed of the car in response to a signal from the car-speed sensor 17 to determine whether the car is stopped, is running at low speed, or is running at high speed (step S122).

If the car is stopped, the communication controller 112 selects the first wireless communication device 26, which corresponds to the first wireless communication system, by priority and switches the third wireless communication device 28 that has been so far selected to the selected first wireless communication system 26 as one to be used for wireless communication with the outside (steps S123 and S126). The communication with the outside is carried out using the first wireless communication device 26 (step S121).

If the car is running at low speed, the communication controller 112 selects the second wireless communication device 27, which corresponds to the second wireless communication system, by priority and switches the third wireless communication device 28 that has been so far selected to the selected second wireless communication system 27 as one to be used for wireless communication with the outside (steps S124 and S126). The communication with the outside is carried out using the second wireless communication device 27 (step S121).

If the car is running at high speed, the communication controller 112 selects the third wireless communication device 28, which corresponds to the third wireless communication system, by priority (step S125). The selected third wireless communication device 28 is the same one that has been so far selected. The communication with the outside is carried out using the third wireless communication device 28 (step S121).

As described above, a method of determining which wireless communication system is used in accordance with the moving speed of the in-car electronic equipment 11 can be applied to both the processes shown in FIGS. 5 and 6.

A roaming process for switching a base station to be used between base stations corresponding to the same wireless communication system will now be described with reference to the flowchart shown in FIG. 8.

In the present embodiment, a high-speed prediction roaming process for predicting a base station targeted for roaming using the base station information database is performed in order to shorten the time required for the roaming process.

In a normal roaming process, a mobile station needs to monitor a beacon signal from a base station around the mobile station, a response signal from the base station to a probe signal transmitted from the mobile station, and the like for a fixed period of time in order to detect the base station.

In contrast, the high-speed prediction roaming process does not require monitoring of a beacon signal or a response signal. It is thus possible to greatly shorten the time required for roaming through the high-speed prediction roaming.

There now follows an explanation of a specific process for high-speed prediction roaming. Roaming between base stations corresponding to the first wireless communication system is taken as an example.

Assume now that the current position of the car 100 is located in point P3 in FIG. 2. The first wireless communication device 26 carries out communication with the outside through the base station BS-A1 shown in FIG. 2 (step S131).

The car 100 moves along the arrow shown in FIG. 2. station can quickly be found even though there are a plurality of candidates for the base station targeted for roaming. The moving direction of the car is sensed by the gyro sensor 18. An average of driving directions may be determined over short intervals of, for example, 5-10 seconds and an average vehicle direction may be calculated and used to determine in which zone or area of the available base stations the vehicle is most likely to spend the greatest period of time so that handoff will be minimized. When the car runs under the guidance of a route, its moving direction can be sensed based on the route. Again a CPU within the communications controller 112 is used to perform an algorithm as described herein for using the vehicle direction as a criteria for selecting the communication device or the base station in a roaming process.

Of course, the direction of movement of the vehicle may be used not only in the roaming situation, but also may be used as a further or replacement criteria in connection with the flowcharts of FIGS. 5-7. For example, if, in FIG. 5, there are two possible base stations which may be used for communication. The priority scheme used in step S102 may be replaced with one selecting the base station based on the direction of the vehicle so that the selected base station will require a low handoff rate station can quickly be found even though there are a plurality of candidates for the base station targeted for roaming. The moving direction of the car is sensed by the gyro sensor 18. An average of driving directions may be determined over short intervals of, for example, 5-10 seconds and an average vehicle direction may be calculated and used to determine in which zone or area of the available base stations the vehicle is most likely to spend the greatest period of time so that handoff will be minimized. When the car runs under the guidance of a route, its moving direction can be sensed based on the route. Again a CPU within the communications controller 112 is used to perform an algorithm as described herein for using the vehicle direction as a criteria for selecting the communication device or the base station in a roaming process.

Of course, the direction of movement of the vehicle may be used not only in the roaming situation, but also may be used as a further or replacement criteria in connection with the flowcharts of FIGS. 5-7. For example, if, in FIG. 5, there are two possible base stations which may be used for communication. The priority scheme used in step S102 may be replaced with one selecting the base station based on the direction of the vehicle so that the selected base station will require a low handoff rate as compared to the non-selected base station.

Returning now to FIG. 8, under the control of the communication controller 112, the first wireless communication device 26 starts a process to be wirelessly connected to the base station BS-A2 in order to establish a session with the base station BS-A2 targeted for roaming (step S134). Since the ID (e.g., address) of the base station BS-A2 can be acquired from the base station information database, the first wireless communication device 26 can actively start the process to be wirelessly connected to the base station BS-A2. The device 26 notifies the base station BS-A2 of the ID of the original base station BS-A1. Thus, a roaming process of switching a base station used by the first wireless communication device 26 from the base station BS-A1 to the base station BS-A2 is performed (step S135). After that, the first wireless communication device 26 performs communication with the outside through the base station BS-A2.

The communication device selecting function and high-speed prediction roaming function of the embodiment of the present invention can be applied to not only in-car electronic equipment but also portable information equipment such as a PDA.

The wireless communication devices 26, 27 and 28 are not necessarily achieved by a physically independent device but can be done by a single wireless communication device capable of selecting a type of a wireless communication system according to software.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus for performing a wireless communication by selectively using one of a first wireless communication device for performing wireless communication by a first wireless communication system and second wireless communication device for performing wireless communication by a second wireless communication system, the electronic apparatus comprising:
means for storing base station information relating to a position of a base station corresponding to the first wireless communication system and a position of a base station corresponding to the second wireless communication system;
a position detector for detecting a current position of the electronic apparatus; and
a switching device for switching between the first wireless communication device and the second wireless communication device based on the current position of the electronic apparatus detected by the position detector and the base station information.

2. The electronic apparatus according to claim 1, wherein the switching device includes:
means for retrieving an ID of a base station having a communication area that covers the current position of the electronic apparatus detected by the position detector from the base station information; and
means for selecting one of the first wireless communication device and the second wireless communication device to be used for communication in accordance with a wireless communication system corresponding to the ID of the base station retrieved by the retrieving means.

3. The electronic apparatus according to claim 1, wherein the electronic apparatus is in-vehicle electronic equipment installed in a vehicle, and the position detector includes means for detecting a current position of the vehicle.

4. The electronic apparatus according to claim 2, wherein the first wireless communication system has a communication speed that is higher than that of the second wireless communication system, and the switching device includes means for selecting the first wireless communication device as having a higher priority than the second wireless communication device when the retrieving means retrieves a base station ID corresponding to the first wireless communication system and also a base station ID corresponding to the second wireless communication system.

5. The electronic apparatus according to claim 2, wherein the electronic apparatus is in-vehicle electronic equipment installed in a vehicle, the first and second wireless communication systems differ from each other in a communication area covered, and the electronic apparatus further comprises speed detecting means for detecting a speed of the vehicle, and the switching device includes means for selecting between the first and second wireless communication devices in accordance with the speed of the vehicle detected by the speed detector when the retrieving means retrieves a base station ID corresponding to the first wireless communication system and also a base station ID corresponding to the second wireless communication system.

6. The electronic apparatus according to claim 1, wherein the switching device includes means for establishing a connection with a partner to which one of the first and second wireless communication device is connected, using the other of the first and second wireless communication devices, when the switching device switches from the one of the first and second wireless communication to the other thereof.

7. The electronic apparatus according to claim 1, further comprising:
means for predicting one of base stations corresponding to the wireless communication system of one of the first and second wireless communication devices as a base station targeted for roaming, based on the current position of the electronic apparatus detected by the position detector and the base station information; and
means for performing a roaming process for switching the base station from a currently wirelessly connected base station to the predicted base station.

8. A wireless communication control method which controls wireless communication performed by an electronic apparatus capable of selectively using one of a first wireless communication device for performing wireless communication by a first wireless communication system and second wireless communication device for performing wireless communication by a second wireless communication system, the method comprising:
detecting a current position of the electronic apparatus; and
switching between the first wireless communication device and the second wireless communication device based on base station information relating to a position of a base station corresponding to the first wireless communication system and that of a base station corresponding to the second wireless communication system and the detected current position of the electronic apparatus.

9. The wireless communication control method according to claim 8, wherein the switching includes:
retrieving a base station ID having a communication area that covers the detected current position of the electronic apparatus from the base station information; and
selecting one of the first wireless communication device and the second wireless communication device in accordance with a wireless communication system corresponding to the retrieved ID of the base station.

10. The wireless communication control method according to claim 8, wherein the electronic apparatus is in-vehicle electronic equipment installed in a vehicle, and the detecting includes detecting a current position of the vehicle.

11. The wireless communication control method according to claim 9, wherein the first wireless communication system has a communication speed that is higher than that of the second wireless communication system, and the switching includes selecting the first wireless communication device as having a higher priority than the second communication device when an ID of a base station corresponding to the first wireless communication system and also an ID of a base station corresponding to the second wireless communication system are retrieved.

12. The wireless communication control method according to claim 9, wherein the electronic apparatus is in-vehicle electronic equipment installed in a vehicle, the first and second wireless communication systems differ from each other in communication area covered by their respective base stations, the method further comprises detecting a moving speed of the vehicle, and the switching includes selecting from the first and second wireless communication devices in accordance with the detected moving speed of the vehicle when an ID of a base station corresponding to the first wireless communication system and also an ID of a base station corresponding to the second wireless communication system are retrieved.

13. The wireless communication control method according to claim 8, wherein the switching includes establishing a connection with a partner to which one of the first and second wireless communication devices is connected, using the other of the first and second wireless communication devices means, switching device switches from the one of the first and second wireless communication to the other thereof.

14. The wireless communication control method according to claim 8, further comprising:
predicting one of base stations corresponding to the wireless communication system of one of the first and second wireless communication devices as a base station targeted for roaming, based on the detected current position of the electronic apparatus and the base station information; and
performing a roaming process for switching the base station from a currently wirelessly connected base station to the predicted base station.

15. The electronic apparatus according to claim 1 further including a position direction determining device for determining the current direction of movement of the electronic apparatus and wherein the switching device switches between the first and second wireless communication devices based additionally on the current direction of movement of the electronic apparatus.

16. The electronic apparatus according to claim 7 further including a position direction determining device for determining the current direction of movement of the electronic apparatus and wherein the predicting means also additionally utilizes on the current direction of movement of the electronic apparatus to determine the base station targeted for roaming.

17. The electronic apparatus according to claim 8 further including determining the current direction of movement of the electronic apparatus and wherein the switching between the first and second wireless communication devices based additionally on the current direction of movement of the electronic apparatus.

18. The electronic apparatus according to claim 14 further including determining the current direction of movement of the electronic apparatus and wherein the predicting also additionally utilizes on the current direction of movement of the electronic apparatus to determine the base station targeted for roaming.

19. An electronic apparatus for performing a wireless communication by selectively using one of a first wireless communication device for performing wireless communication by a first wireless communication system and second wireless communication device for performing wireless communication by a second wireless communication system, the electronic apparatus comprising:
means for storing base station information relating to an environment of a base station corresponding to the first wireless communication system and an environment of a base station corresponding to the second wireless communication system;
a position detector for detecting a current position of the electronic apparatus; and
a switching device for switching between the first wireless communication device and the second wireless communication device based on the current position of the electronic apparatus detected by the position detector and the base station information.

20. A wireless communication control method which controls wireless communication performed by an electronic apparatus capable of selectively using one of a first wireless communication device for performing wireless communication by a first wireless communication system and second wireless communication device for performing wireless communication by a second wireless communication system, the method comprising:
detecting a current position of the electronic apparatus; and
switching between the first wireless communication device and the second wireless communication device based on base station information relating to an environment of a base station corresponding to the first wireless communication system and that of a base station corresponding to the second wireless communication system and the detected current position of the electronic apparatus.
